(19) United States
(12) Patent Application Publication
(10) Pub. No.: US 2026/0081801 A1
(43) Pub. Date: Mar. 19, 2026

(54) TOKEN-BASED FEATURE CONTROL IN A VIRTUAL MEETING

(71) Applicant: Google LLC, Mountain View, CA (US)

(72) Inventor: Stefan Lindmark, Östhammar (SE)

(21) Appl. No.: 18/887,591

(22) Filed: Sep. 17, 2024

(51) Int. Cl. H04L 12/18

(52) U.S. Cl. CPC H04L 12/1818

(57) ABSTRACT

A system and method for token-based feature control in a virtual meeting, with operations including determining that a first feature of a virtual meeting is requested by a first participant of the virtual meeting; determining a number of tokens allocated to the first participant in connection with the virtual meeting; determining that a subset of unused tokens of the number of tokens have not been used by the participant during the virtual meeting; determining whether the subset of unused tokens satisfies a first feature threshold criterion; and responsive to determining the subset of unused tokens satisfies the first feature threshold criterion, allowing the first feature to be used by the first participant during the virtual meeting.

### TECHNICAL FIELD

Aspects and implementations of the present disclosure relate to token-based feature control in virtual meetings.

### BACKGROUND

Virtual meetings may provide participants with various features to communicate in the virtual meeting. Communication features, such as a mute/unmute feature can determine how participant data including audio data, video data, and/or user input data is captured and/or presented at a client device. A designated participant, such as a host or moderator, may control which features are allowed to be used by participants of the virtual meeting.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

An aspect of the disclosure provides a computer-implemented method including: determining that a first feature of a virtual meeting is requested by a first participant of the virtual meeting; determining a number of tokens allocated to the first participant in connection with the virtual meeting; determining that a subset of unused tokens of the number of tokens have not been used by the participant during the virtual meeting; determining whether the subset of unused tokens satisfies a first feature threshold criterion; and responsive to determining the subset of unused tokens satisfies the first feature threshold criterion, allowing the first feature to be used by the first participant during the virtual meeting.

In some aspects, the method further comprises: responsive to determining the subset of unused tokens does not satisfy the first feature threshold criterion, disallowing the first feature to be used by the first participant during the virtual meeting.

In some aspects, the method further comprises: causing a visual representation indicating that the first feature is allowed to be used by the first participant to be visually rendered via a graphical user interface (GUI) of the virtual meeting.

In some aspects, the method further comprises: determining to disallow the first participant to use the first feature; and responsive to determining to disallow the first participant to use the first feature, increasing the first threshold criterion such that the subset of unused tokens does not satisfy the first feature threshold criterion.

In some aspects, the method further comprises: allocating a first number of tokens to the subset of unused tokens of the first participant during the virtual meeting; and allocating a second number of tokens to a second subset of unused tokens of a second participant of the virtual meeting during the virtual meeting.

In some aspects, the method further comprises: allocating a first number of tokens to the subset of unused tokens of the first participant during a portion of the virtual meeting session.

In some aspects, the method further comprises: determining that the first participant has used a second feature of the virtual meeting session; and allocating a first number of tokens to the first participant in response to determining that the first participant has used the second feature.

In some aspects, the method further comprises: responsive to allowing the first feature to be used by the first participant during the virtual meeting session, causing the subset of unused tokens to be returned to a token allocation pool of the virtual meeting session.

An aspect of the disclosure provides a computer-implemented method including: providing a user interface for allocating tokens to be used in a virtual meeting having a plurality of features; receiving a user input identifying the virtual meeting via the user interface; receiving a user input specifying a number of tokens allocated to each participant of a plurality of participants of the virtual meeting via the user interface; and storing the number of allocated tokens in association with an identifier of the virtual meeting to cause use of the plurality of features to be managed during the virtual meeting according to the number of tokens allocated to each participant of the plurality of participants.

In some aspects, receiving a user input specifying a plurality of threshold criteria, each threshold criterion of the plurality of threshold criteria pertaining to a feature of the plurality of features; and storing the plurality of threshold criteria in association with the identifier of the virtual meeting to cause use of the plurality of features to be managed during the virtual meeting according to each threshold criterion of the plurality of threshold criteria.

In some aspects, the method further comprises: receiving a user input specifying to not allow a first participant of the plurality of participants to use a first feature of the plurality of features via the user interface; and updating a first threshold criterion for the first feature associated the first participant.

In some aspects, the method further comprises: receiving a user input specifying to not allow the plurality of participants to use a first feature of the plurality of features via the user interface; and updating a first threshold criterion for the first feature associated with the plurality of participants.

In some aspects, the method further comprises: receiving a user input indicating to adjust a first number of tokens allocated to a first participant of the plurality of participants; and updating a first number of allocated tokens in association with the identifier of the virtual meeting corresponding to the first participant.

In some aspects, the method further comprises: receiving a user input indicating to not allow a sub-plurality of the plurality of participants to use the plurality of features; and updating the number of allocated tokens in association with the identifier of the virtual meeting to not allow the sub-plurality of participants to use the plurality of features of the virtual meeting.

An aspect of the disclosure provides a system comprising a memory and one or more processing devices to perform operations comprising: determining that a first feature of a virtual meeting is requested by a first participant of the virtual meeting; determining a number of tokens allocated to the first participant in connection with the virtual meeting; determining that a subset of unused tokens of the number of tokens have not been used by the participant during the virtual meeting; determining whether the subset of unused tokens satisfies a first feature threshold criterion; and responsive to determining the subset of unused tokens satisfies the first feature threshold criterion, allowing the first feature to be used by the first participant during the virtual meeting.

In some aspects, the one or more processing devices to perform operations further comprising: responsive to determining the subset of unused tokens does not satisfy the first feature threshold criterion, disallowing the first feature to be used by the first participant during the virtual meeting.

In some aspects, the one or more processing devices to perform operations further comprising: determining to disallow the first participant to use the first feature; and responsive to determining to disallow the first participant to use the first feature, increasing the first threshold criterion such that the subset of unused tokens does not satisfy the first feature threshold criterion.

In some aspects, the one or more processing devices to perform operations further comprising: allocating a first number of tokens to the subset of unused tokens of the first participant during the virtual meeting; and allocating a second number of tokens to a second subset of unused tokens of a second participant of the virtual meeting during the virtual meeting.

In some aspects, the one or more processing devices to perform operations further comprising: allocating a first number of tokens to the subset of unused tokens of the first participant during a portion of the virtual meeting session.

In some aspects, the one or more processing devices to perform operations further comprising: determining that the first participant has used a second feature of the virtual meeting session; and allocating a first number of tokens to the first participant in response to determining that the first participant has used the second feature.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of a system architecture, according to aspects of the disclosure.

FIG. 2 is an example graphical user interface (GUI) for token-based feature control in a virtual meeting, according to some aspects of the disclosure.

FIG. 3 is an example graphical user interface (GUI) for token-based feature control in a virtual meeting, according to some aspects of the disclosure.

FIG. 4 is a flow diagram of an example method for token-based feature control in a virtual meeting, according to some aspects of the disclosure.

FIG. 5 is a flow diagram of an example method for token-based feature control in a virtual meeting, according to some aspects of the disclosure.

FIG. 6 is a flow diagram of an example method for token-based feature control in a virtual meeting, according to some aspects of the disclosure.

FIG. 7 is a flow diagram of an example method for token-based feature control in a virtual meeting, according to some aspects of the disclosure.

FIG. 8 is a block diagram illustrating an example of a computer system, according to aspects of the disclosure.

### DETAILED DESCRIPTION

Aspects of the present disclosure relate to token-based feature control in virtual meetings. A virtual meeting can refer to a meeting that is attended by participants using respective client devices connected to a virtual meeting platform. A client device connected to the virtual meeting platform captures and transmits image data (e.g., collected by a camera of the client device) and/or audio data (e.g., collected by a microphone of the client device) to other client devices connected to the virtual meeting platform. The image data may depict a user (e.g., a participant) or a group of users that are participating in the virtual meeting. The audio data may include an audio recording of audio provided by the user or group of users during the virtual meeting. A virtual meeting platform can enable video-based conferences between multiple participants via respective client devices that are connected over a network and share each other's audio (e.g., voice of a user recorded via a microphone of a client device) and/or video streams (e.g., a video captured by a camera of a client device) during a virtual meeting. In some instances, a virtual meeting platform can enable a significant number of client devices (e.g., one hundred thousand or more client devices) to be connected via the virtual meeting.

Communication between participants of the virtual meeting may be moderated. Moderation of communication between participants may maintain order in the virtual meeting, improve the quality of discussions, prevent inappropriate disruptions from participants, or the like. Moderation may be performed on the content shared in communication between participants (e.g., video data or audio data of the participant, digital content such as screen sharing, messages sent by participants, etc.). Moderation may also be used to allow or disallow participants of the virtual meeting to use certain communication features (also referred to herein as “features”) of the virtual meeting. These features may include, for example, unmuting of a microphone, sharing of participant captured video or participant device screens (e.g., “screen-sharing”), messaging and/or reaction functions integrated into the virtual meeting, and the like. For example, moderation may be performed to prevent a participant from overusing or abusing a feature of the virtual meeting to disrupt the meeting, such as to prevent a participant from sending hundreds of messages in a matter of seconds. In another example, moderation may be performed to more evenly balance the participation of virtual meeting participants, such as by limiting the available speaking time of over-participating participants and increasing the speaking time of under-participating participants. In another example, moderation may be performed when features of the virtual meeting cause the current topic of the virtual meeting to diverge from an intended topic.

In some virtual meeting services, the moderation may be performed automatically or semi-automatically by integrated tools of the virtual meeting service. For example, these tools may detect when a feature of the virtual meeting is being abused to disrupt the virtual meeting, such as when a participant is sending tens or hundreds of messages over a relatively short time interval (e.g., thirty seconds). Once the abuse is detected, the integrated tools can limit the use of the feature by certain participants in an attempt to reduce the abuse of the feature. However, in order to prevent false positive identifications of feature abuse, the threshold criteria that trigger these automatic moderation tools can be relatively high, which can still allow feature abuse before they the automatic moderation be triggered.

Additionally, in many virtual meeting services, the number of client devices permitted to connect to the virtual meeting may be limited at least in part based on the moderation capabilities of the virtual meeting (e.g., the ability of the human moderator to moderate the communication of participants).

Aspects of the present disclosure address these and other challenges by providing for token-based feature control in virtual meetings. Each participant of the virtual meeting is allocated a number of tokens by a token allocation module. When a participant uses a feature of the virtual meeting, a certain number of unused tokens corresponding to the feature are either extinguished, or returned to the token allocation module. For example, if the threshold criterion for using the unmute feature is two tokens, a participant with ten tokens that uses the unmute feature will then have eight unused tokens, with two tokens having been extinguished or returned. If the number of tokens to use a feature exceeds a number of tokens allocated to the participant, the participant is disallowed from using the feature. For example, if a participant has one token and the threshold criterion for using the unmute feature is two tokens, the participant will be disallowed from using the unmute feature.

In some implementations, the token allocation module can allocate tokens to participants before the virtual meeting begins. In some implementations, tokens can be allocated to participants during the virtual meeting. In some implementations, different quantities of tokens can be allocated to different participants of the virtual meeting. For example, ten tokens can be allocated to a first participant while five tokens are allocated to a second participant. In some implementations, the threshold criterion number of tokens for using a given feature (e.g., a feature threshold criterion) can be determined before the virtual meeting begins. In some implementations, the feature threshold criterion can be set or adjusted during the virtual meeting.

Advantages of providing for token-based feature control in virtual meetings include improved moderation of virtual meetings, granular control of automatic or semi-automatic moderation of virtual meetings, dynamic moderation control during virtual meetings, and a larger number of client devices permitted to connect to a virtual meeting.

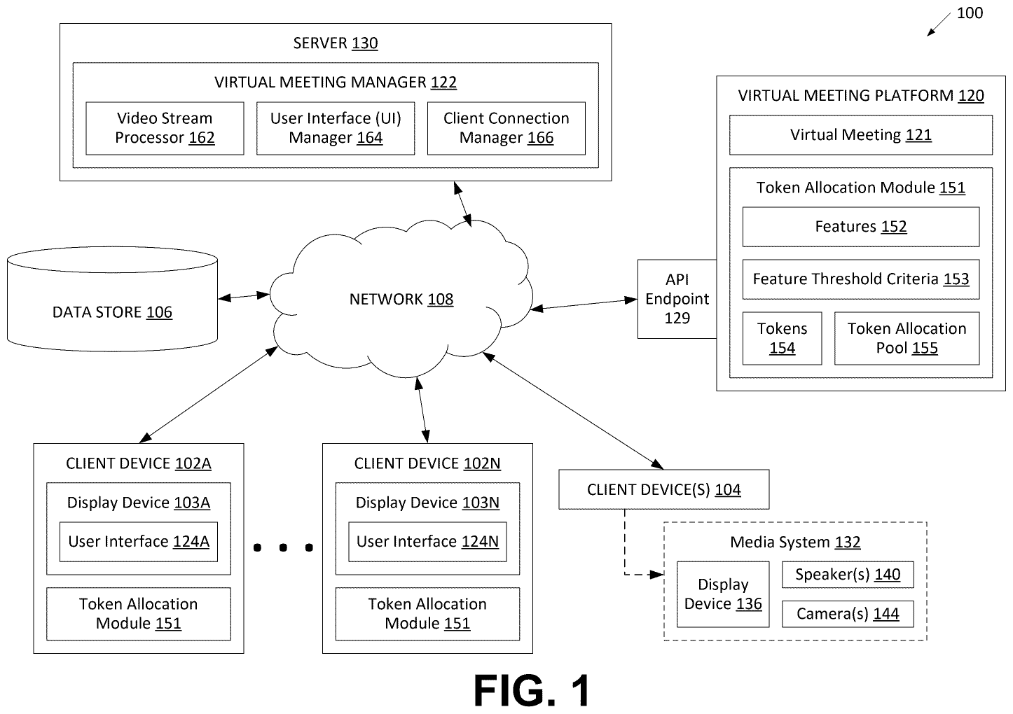

FIG. 1 illustrates an example of a system 100, according to some aspects of the disclosure. The system 100 includes client devices 102A-N, one or more client device(s) 104, a data store 106, a virtual meeting platform 120, and a server 130, each connected to a network 108.

In implementations, network 108 can include a public network (e.g., the Internet), a private network (e.g., a local area network (LAN) or wide area network (WAN)), a wired network (e.g., Ethernet network), a wireless network (e.g., an 802.11 network or a wireless fidelity (Wi-Fi) network), a cellular network (e.g., a Long Term Evolution (LTE) network), routers, hubs, switches, server computers, and/or a combination thereof.

Data store 106 is a persistent storage that is capable of storing data as well as data structures to tag, organize, and index the data. In some implementations, data can include one or more of structured data, unstructured data, vectorized data, etc., or types of digital files, including text data, audio data, image data, video data, multimedia, interactive media, data objects, and/or any suitable type of digital resource, among other types of data. An example of data stored at the data store 106 can include a file, database record, database entry, programming code or document, among others. The data store 106 can be hosted by one or more storage devices, such as main memory, magnetic or optical storage based disks, tapes or hard drives, network-attached storage (NAS), storage area network (SAN), and so forth. In some implementations, the data store 106 can be a network-attached file server, while in other implementations the data store 106 can be another type of persistent storage such as an object-oriented database, a relational database, and so forth, that can be hosted by virtual meeting platform 120, or one or more different machines coupled to the server hosting the virtual meeting platform 120 via the network 108.

Virtual meeting platform 120 can enable users of client devices 102A-102N and/or client device(s) 104 to connect with each other via a virtual meeting (e.g., a virtual meeting 121). A virtual meeting 121 refers to a real-time communication session such as a virtual meeting call, also known as a video-based call or video chat, in which participants can connect with multiple additional participants in real-time and be provided with audio and/or video capabilities. Real-time communication refers to the ability for participants to communicate (e.g., exchange information) instantly without transmission delays and/or with negligible (e.g., milliseconds or microseconds) latency. Virtual meeting platform 120 can allow a user (e.g., a participant of the virtual meeting) to join and participate in a virtual meeting 121 with other users of the platform (e.g., other participants of the virtual meeting). Implementations of the present disclosure can be implemented with any number of participants connecting via the virtual meeting 121.

The virtual meeting platform 120 can include a token allocation module 151. In some implementations, the token allocation module 151 is included in the virtual meeting manager 122. The token allocation module 151 can manage the allocation of tokens 154 to participants. In some implementations, the token allocation module 151 can extinguish tokens that have been used by a participant to access a feature 152 of the virtual meeting 121. In alternative implementations, the token allocation module 151 can receive the tokens that have been used by participants to access a feature 152 of the virtual meeting 121.

The token allocation module 151 can include features 152 and associated feature threshold criteria 153 for a virtual meeting 121. The token allocation module 151 can include a list or set of features 152 that a participant is allowed to use during the virtual meeting. The token allocation module 151 can include a corresponding list or set of feature threshold criteria 153 associated with each feature 152 that a participant may use during a virtual meeting. As described above, a feature threshold criterion 153 for a feature 152 can refer to a number of tokens 154 that are extinguished or returned to the token allocation module 151 (e.g., the token allocation pool 155) when a participant uses the feature 152. For example, two of a participant's unused tokens 154 may be returned to the token allocation pool 155 when a participant unmutes their microphone (e.g., a feature 152). The token allocation module 151 may allocate tokens 154 to current or future participants of the virtual meeting 121. The token allocation module 151 may track a number of tokens 154 that are allocated to a participant at any given time during the virtual meeting 121. In some implementations, the token allocation module 151 may track a number of the tokens in the token allocation pool 155 of the token allocation module 151. In some implementations, the token allocation pool 155 has a maximum number of tokens for a virtual meeting 121. Tokens 154 that have been used by participants are returned to the token allocation pool 155 and thus can be used for further allocations to participants of the virtual meeting 121. In some implementations, the token allocation pool 155 does not have a maximum number of tokens or a virtual meeting 121. Tokens 154 used by participants may be returned to the token allocation pool 155 or extinguished once the feature 152 is accessed by the participant.

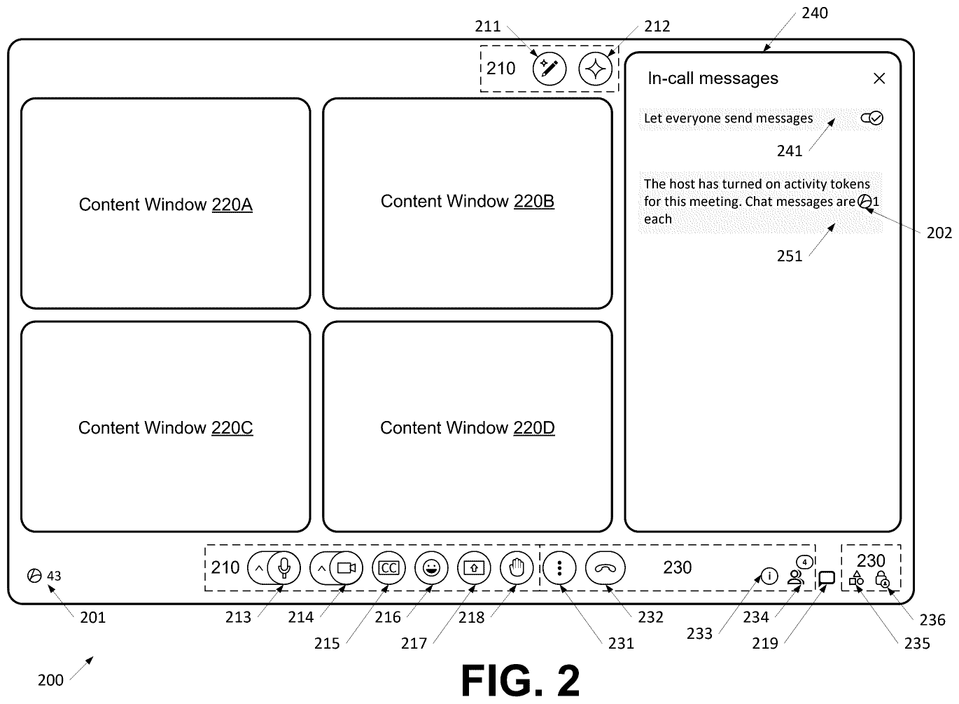

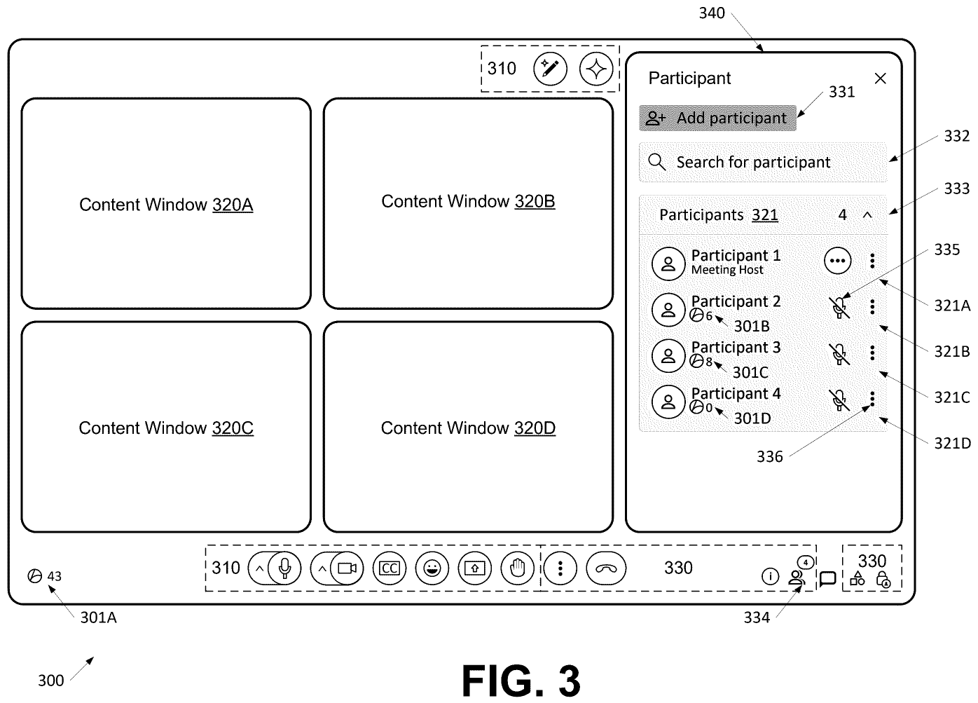

A virtual meeting organizer or participant-host can configure one or more settings of the token allocation module 151 of the virtual meeting platform 120 (e.g., via a user interface 124A-124N). In some implementations, the token allocation module 151 can provide the organizer or participant-host with pre-selected or “default” token allocation settings for a virtual meeting. For example, a pre-selected virtual meeting configuration may cause the token allocation module 151 to allocate a certain number of tokens 154 to each participant of the virtual meeting 121, allow a certain features 152, and set certain corresponding values for the feature threshold criteria 153. In some implementations, the default values provided by the token allocation module 151 for a virtual meeting before the virtual meeting begins. In some implementations, the features 152, feature threshold criteria 153, and number of tokens 154 allocated to participants may be altered by the token allocation module 151 while the virtual meeting is in progress. In some implementations, an organizer of the virtual meeting or host-participant can cause the token allocation module 151 to perform one or more of the above or other functions (e.g., through one of user interfaces 124A-124N). Additional details regarding the allocation of tokens 154 is described below with reference to FIG. 2 and FIG. 3.

The client devices 102A-102N can each include computing devices such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some implementations, client devices 102A-102N can be one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components. In some implementations, client devices 102A-102N can also be referred to as “user devices.” Each client device 102A-102N can include an audiovisual component that can generate audio and video data to be streamed to virtual meeting platform 120. In some implementations, the audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user (e.g., a virtual meeting participant) associated with a particular client device. In some implementations, the audiovisual component can also include an image capture device (e.g., a camera) to capture images and generate video data (e.g., a video stream) of the captured data of the captured images.

In some implementations, the client devices 102A-102N can implement or include one or more applications to communicate (e.g., send and receive information) with the virtual meeting platform 120. In some implementations, the client devices 102A-102N can implement user interfaces (UIs) (e.g., graphical user interfaces (GUIs)), such as a user interface 124A-124N) that may be webpages rendered by a web browser and displayed on the client devices 102A-102N in a web browser window. In another embodiment, the user interface 124A-124N of the client devices 102A-102N may be included in a stand-alone application downloaded to the client devices 102A-102N and natively running on the client devices 102A-102N (also referred to as a “native application” or “native client application” herein). In some implementations, some or all portions of the token allocation module 151 can be implemented at the client device 102A-102N.

In some implementations, the virtual meeting platform 120 is coupled, via network 108, with one or more client device(s) 104 that are each associated with a physical conference or meeting room. Client device(s) 104 can include or be coupled to a media system 132 that can include one or more display devices 136, one or more speakers 140 and one or more cameras 144. Display device 136 can be, for example, a smart display or a non-smart display (e.g., a display that is not itself configured to connect to network 108). Users that are physically present in the room can use the media system 132 rather than their own devices (e.g., client devices 102A-102N) to participate in virtual meeting 121, which can include other remote users. For example, the users in the room that participate in the virtual meeting can control the display device 136 to show a slide presentation or watch slide presentations of other participants. Sound and/or camera control can similarly be performed. Similar to client devices 102A-102N, client device(s) 104 can generate audio and video data to be streamed to virtual meeting platform 120 (e.g., using one or more microphones, speakers 140 and cameras 144).

Each client device 102A-102N or client device(s) 104 can include a browser and/or a client application (e.g., a mobile application, a desktop application, etc.). In some implementations, the web browser and/or the client application can present, on a display device 103A-103N of client device 102A-102N, a user interface (UI) (e.g., a UI of the UIs 124A-124N) for users to access the virtual meeting platform 120. For example, a user of client device 102A can join and participate in a virtual meeting via a UI 124A presented on the display device 103A by the web browser or client application. A user can also present a document to participants of the virtual meeting via each of the UIs 124A-124N. Each of the UIs 124A-124N can include multiple regions to present video streams corresponding to video streams of the client devices 102A-102N provided to the server 130 for the virtual meeting. In some implementations, the UIs 124A-124N may include various visual elements (e.g., UI elements) and regions, and can be a mechanism by which the user engages with the virtual meeting platform 120, and system 100 at large. In some implementations, the UIs 124A-124N of the client devices 102A-102N can include multiple visual elements and regions that enable presentation of information, for decision-making, content delivery, etc. at the client devices 102A-102N. In some implementations, the UIs 124A-124N may sometimes be referred to as a graphical user interface (GUI)).

In some implementations, the UIs 124A-124N and/or client devices 102A-102N can include input features to intake information from a client devices 102A-102N. In one or more examples, a user of client devices 102A-102N can provide input data (e.g., a user query, control commands, etc.) into an input feature of the UIs 124A-124N or client devices 102A-102N, for transmission to the virtual meeting platform 120, and system 100 at large. Input features of UIs 124A-124N and/or client devices 102A-102N can include space, regions, or elements of the UIs 124A-124N that accept user inputs. For example, input features may include visual elements (e.g., GUI elements) such as buttons, text-entry spaces, selection lists, drop-down lists, etc. For example, in some implementations, input features may include a chat box which a user of client devices 102A-102N can use to input textual data (e.g., a user query). The client devices 102A-102N can then transmit that textual data to virtual meeting platform 120, and the system 100 at large, for further processing. In other examples, input features can include a selection list, in which a user of client devices 102A-102N can input selection data e.g., by selecting, or clicking. The client devices 102A-102N can then transmit that selection data to virtual meeting platform 120, and the system 100 at large, for further processing.

In some implementations, server 130 can include a virtual meeting manager 122. Virtual meeting manager 122 is configured to manage a virtual meeting between multiple users of virtual meeting platform 120. In some implementations, the virtual meeting manager 122 can provide the UIs 124A-124N to each client device to enable users to watch and listen to each other during a virtual meeting. Virtual meeting manager 122 can also collect and provide data associated with the virtual meeting to each participant of virtual meeting 121. In some implementations, virtual meeting manager 122 can provide the UIs 124A-124N for presentation by a client application (e.g., a mobile application, a desktop application, etc.). For example, the UIs 124A-124N can be displayed on a display device 103A-103N by a native application executing on the operating system of the client device 120A-120N or the client device(s) 104. The native application can be separate from a web browser. In some implementations, the virtual meeting manager 122 can determine visual items for presentation in the UI 124A-124N during a virtual meeting. A visual item can refer to a UI element that occupies a particular region in the UI and is dedicated to presenting a video stream from a respective client device. Such a video stream can depict, for example, a user of the respective client device while the user is participating in the virtual meeting (e.g., speaking, presenting, listening to other participants, watching other participants, etc., at particular moments during the virtual meeting), a physical conference or meeting room (e.g., with one or more participants present), a document or other media content (e.g., video content, one or more images, etc.) being presented during the virtual meeting, and the like. It is appreciated that providing video streams for presentation is described herein by way of example, and not limitations, noting that aspects and implementations of the present disclosure can be applied to other visual items (e.g., recorded videos) without deviating from the scope of the present disclosure.

In some implementations, the virtual meeting manager 122 includes a video stream processor 162, a user interface (UI) manager 164, and a client connection manager 166. The components can be combined together or separated into further components, according to a particular implementation. It should be noted that in some implementations, various components of the virtual meeting manager 122 can run on separate machines.

The video stream processor 162 can receive video streams from client devices 102A-102N and/or client device(s) 104. The video stream processor 162 can determine video streams for presentation in the UIs 124A-124N during the virtual meeting 121. Each video stream can correspond to a video stream from a client device (e.g., the video stream pertaining to one or more participants of the virtual meeting). In some implementations, the video stream processor 162 can receive audio streams associated with the video streams from the client devices (e.g., from an audiovisual component of the client devices 102A-102N).

The User Interface (UI) manager 164 can provide a UI for a virtual meeting. The UI can include multiple regions. Each region can display a video stream pertaining to one or more participants of the virtual meeting. The UI manager 164 can control which video stream is to be displayed by providing a command to the client devices that indicates which video stream is to be displayed in which region of the UI (along with the received video and audio streams being provided to the client devices). For example, in response to being notified of the determined video streams for presentation in the UI 124A-124N, the UI manager 164 can transmit a command causing each determined video streams to be displayed in a region of the UI and/or rearranged in the UI.

A participant can join and participate in a virtual meeting via a UI 124A presented on the display device 103A by the web browser or client application. As described previously, an audiovisual component of each client device can capture images and generate video data (e.g., a video stream) of the captured data of the captured images. In some implementations, the client devices 102A-102N and/or client device(s) 104 can transmit the generated video stream to virtual meeting manager 122. The audiovisual component of each client device can also capture an audio signal representing speech of a user and generate audio data (e.g., an audio file or audio stream) based on the captured audio signal. In some implementations, the client devices 102A-102N and/or client device(s) 104 can transmit the generated audio data to virtual meeting manager 122.

In some implementations, a client device 102A can access the virtual meeting platform 120 through network 108 using one or more application programming interface (API) calls via platform API endpoint 129. In some implementations, virtual meeting platform 120 can include multiple platform API endpoints 129 that can expose services, functionality, or information of the virtual meeting platform 120 to one or more client devices 102A-102N. In some implementations, a platform API endpoint 129 can be one end of a communication channel, where the other end can be another system, such as a client device 102A associated with a participant or user account. In some implementations, the platform API endpoint 129 can include or be accessed using a resource locator, such a universal resource identifier (URI), universal resource locator (URL), of a server or service. The platform API endpoint 129 can receive requests from other systems, and in some cases, return a response with information responsive to the request. In some implementations, HTTP (Hypertext Transfer Protocol), HTTPS (Hypertext Transfer Protocol Secure) methods (e.g., API calls) can be used to communicate to and from the platform API endpoint 129.

In some implementations, the platform API endpoint 129 can function as a computer interface through which access requests are received and/or created. In some implementations, the platform API endpoint 129 can include a platform API whereby external entities or systems can request access to services and/or information provided by the virtual meeting platform 120. The platform API can be used to programmatically obtain services and/or information associated with a request for services and/or information.

In some implementations, the API of the platform API endpoint 129 can be any suitable type of API such as a REST (Representational State Transfer) API, a GraphQL API, a SOAP (Simple Object Access Protocol) API, and/or any suitable type of API. In some implementations, the virtual meeting platform 120 can expose through the API, a set of API resources which when addressed can be used for requesting different actions, inspecting state or data, and/or otherwise interacting with the virtual meeting platform 120. In some implementations, a REST API and/or another type of API can work according to an application layer request and response model. An application layer request and response model can use HTTP, HTTPS, SPDY, or any suitable application layer protocol. Herein HTTP-based protocol is described for purposes of illustration, rather than limitation. The disclosure should not be interpreted as being limited to the HTTP protocol. HTTP requests (or any suitable request communication) to the virtual meeting platform 120 can observe the principals of a RESTful design or the protocol of the type of API. RESTful is understood in this document to describe a Representational State Transfer architecture. The RESTful HTTP requests can be stateless, thus each message communicated contains all necessary information for processing the request and generating a response. The platform API can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

It can be appreciated that in some implementations, any element, such as server 130, and/or data store 106 may include a corresponding API endpoint for communicating with APIs.

In some implementations, virtual meeting platform 120 and/or server 130 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to enable a user to connect with other users via a virtual meeting. Virtual meeting platform 120 can also include a website (e.g., a webpage) or application back-end software that may be used to enable a user to connect with other users via virtual meeting 121.

It is appreciated that in some other implementations, the functions of server 130 or virtual meeting platform 120 can be provided by a fewer number of machines. For example, in some implementations, server 130 can be integrated into a single machine, while in other implementations, server 130 can be integrated into multiple machines. In addition, in some implementations, server 130 can be integrated into virtual meeting platform 120.

In general, functions described in implementations as being performed by virtual meeting platform 120 or server 130 can also be performed by the client devices 102A-102N and/or client device(s) 104 in other implementations, if appropriate. In addition, the functionality attributed to a particular component can be performed by different or multiple components operating together. Virtual meeting platform 120 and/or server 130 may also be accessed as a service provided to other systems or devices through appropriate application programming interfaces, and thus is not limited to use in websites.

Although implementations of the disclosure are discussed in terms of virtual meeting platform 120 and users of virtual meeting platform 120 participating in a virtual meeting, implementations can also be generally applied to any type of telephone call or conference call between users. Implementations of the disclosure are not limited to virtual meeting platforms that provide virtual meeting tools to users.

In implementations of the disclosure, a “user” or “participant” can be represented as a single individual. However, other implementations of the disclosure encompass a “user” or “participant” being an entity controlled by a set of users and/or an automated source. For example, a set of individual users federated as a community in a social network may be considered a “user” or “participant.” In another example, an automated consumer can be an automated ingestion pipeline, such as a topic channel, of the virtual meeting platform 120.

In situations in which the systems discussed here collect personal information about users, or may make use of personal information, the users can be provided with an opportunity to control whether virtual meeting platform 120 collects user information (e.g., information about a user's social network, social actions or activities, profession, a user's preferences, or a user's current location), or to control whether and/or how to receive content from the server 130 that can be more relevant to the user. In addition, certain data can be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the virtual meeting platform 120 and/or server 130.

FIG. 2 is an example graphical user interface (GUI) 200 for token-based feature control in a virtual meeting, according to some aspects of the disclosure. The GUI 200 includes examples of features 210 that participants may use during a virtual meeting, content window 220A-220D, virtual meeting tools 230, and a navigation panel 240. The GUI 200 also displays a number of unused tokens 201 currently allocated to the participant viewing the GUI 200. In some implementations, the GUI 200 is representative of a host-participant GUI. The GUI 200 visually illustrates actions that can be performed by a token allocation module, such as token allocation module 151 of FIG. 1. In some implementations, settings of the token allocation module can be configured based on user input, such as user input received through the GUI 200.

Features 210 can include, for example, one or more of an artificial intelligence (AI) note-taking feature 211, an AI integration feature 212, a microphone control feature 213, a camera control feature 214, a caption feature 215, a reaction feature 216, a presentation feature 217, a hand-raise feature 218, a messaging feature 219, or the like. The AI note-taking feature 211 can allow a trained large language model (LLM) to generate meeting notes based on audio data, messages, and/or transcripts generated from the audio data. The AI integration feature 212 can include additional AI features, such as for example, prompt inputs for an LLM, based on context in the virtual meeting. The microphone control feature 213 can allow a participant to enable or disable the capture of audio data for the virtual meeting (e.g., from a microphone). The camera control feature 214 can allow a participant to enable or disable the capture of video data for the virtual meeting (e.g., from a camera). The captions feature 215 can allow the participant to enable a display of a textual interpretation of audio data of the virtual meeting. The reactions feature 216 can allow a participant to send a reaction, such as an emoji, to be displayed to participants of the virtual meeting. The presentation feature 217 can allow the participant to share the participant's screen or other digital materials. The hand-raise feature 218 can allow the participant to notify the host, and/or other participants of the virtual meeting, that the participant would like to contribute to a conversation of the virtual meeting. The messaging feature 219 can allow a participant to send text, audio, images, video, files, or the like to the host, another participant or group of participants, or all participants of the virtual meeting.

Each feature 210 can be associated with a feature threshold criterion 202. As described above with reference to FIG. 1, the feature threshold criterion 202 can refer to the number of tokens 201 that are extinguished or returned to the token allocation module when a respective participant uses one of the features 210. For example and in some implementations, the microphone control feature 213 can have a feature threshold criterion 202 of two tokens. In the illustrative FIG. 2, the feature threshold criterion 202 for sending a chat message (e.g., a feature 210) is one token. In the illustrative FIG. 2, after a participant uses the microphone control feature 213, the number of tokens 201 can decrease from forty-three to forty-two, and the GUI 200 can be updated to reflect the new number of unused tokens 201.

The virtual meeting platform, via the token allocation module can set respective feature threshold criterions 202 for each feature 210 that will be available to participants in the virtual meeting. In some implementations, the feature threshold criterions 202 can be set or modified based on an input received from the host or organizer of the virtual meeting. In some implementations, the feature threshold criterion 202 for a feature 210 can be set to zero, or otherwise configured such that a participant can use the feature 210 without extinguishing or returning their tokens 201. In some implementations, a feature 210 can be disabled (e.g., not available for use by participants) by setting the associated feature threshold criterion 202 to a null value, or to a value that exceeds a number of tokens 201 that are (or will be) allocated to participants of the virtual meeting. In some implementations, features 210 that have been removed from the virtual meeting can be displayed in the GUI 200 as a greyed-out icon, or similar. In some implementations, features 210 that have been removed from the virtual meeting are not displayed in the GUI 200.

In some implementations, the virtual meeting platform can set a different value of the feature threshold criterion 202 for a feature 210 for different participants. For example, and in some implementations, the feature threshold criterion 202 for the camera control feature 214 can be two tokens for a first participant, and three tokens for a second participant. In some implementations, the feature threshold criterion 202 for a feature 210 can be a negative number. That is, virtual meeting platform (e.g., via the token allocation module) can allocate tokens to a participant that uses the feature 210. Negative values for the feature threshold criterion 202 can allow the virtual meeting platform to incentivize the use of certain features. For example, and in some implementations, the hand-raise feature 218 in a classroom can have a feature threshold criterion 202 that is set to a negative value to incentivize the orderly participation of students in the virtual meeting.

Content windows 220A-220D are elements of a graphical interface that can display content that represents respective participants in the virtual meeting. That is, content windows 220A-220D can display a visual representation of a respective participant, or a visual representation of content provided by the participant, including audio data or image data captured by a participant's client device. For example, content window 220A can represent content received from a client device associated with the first participant, content window 220B can represent content received from a client device associated with a second participant, content window 220C can represent content received from client device associated with a third participant, and content window 220D can represent content received from a client device associated with a fourth participant. In some implementations, the content window 220A-220D displayed in the GUI 200 for participants can be based on a participant's use of one or more features 210. For example and in some implementations, the participant represented by content window 220A can enable video data capture using the camera control feature 214, and the content window 220A can be used for displaying the video data captured from the client device used by the participant. In another example and in some implementations, a participant represented by content window 220B can use the presentation feature 217 to cause digital content to be displayed in the content window 220B.

The virtual meeting tools 230 can be used by the participant to control various elements of the virtual meeting, and/or the GUI 200. The virtual meeting tools 230 can include one or more of a virtual meeting options element 231, an end call element 232, a meeting details element 233, a participant(s) details element 234, an activities element 235, a host controls element 236, or the like. The virtual meeting tools 230 can be displayed in the GUI 200 based on the role of the participant in the virtual meeting. For example and in some implementations, the host controls element 236 may not be displayed in the GUI 200 of a non-host participant of the virtual meeting.

In some implementations, one or more of the virtual meeting tools 230 can include or be associated with a feature 210 of the virtual meeting. For example, the virtual meeting options element 231 can include one or more of a whiteboard feature, a picture-in-picture feature, a video visual effects feature, a recording feature, or the like. These additional features may each be associated with a feature threshold criterion 202. As described above, in some implementations if a feature 210 (e.g., selected from a virtual meeting tool 230) is not available, the corresponding GUI element may be greyed out, or not visible to the participant.

The navigation panel 240 can be used to display various elements of the GUI 200, based on a selected feature 210 or virtual meeting tool 230. In the illustrative FIG. 2, the navigation panel 240 displays the messaging panel for the virtual meeting. The illustrative FIG. 2 shows a GUI 200 presented to the host-participant of the virtual meeting, which includes the allow messaging element 241. It can be appreciated that the allow messaging element 241 is not present in the GUIs 200 of non-host participants of the virtual meeting. The navigation panel 240 in the illustrative FIG. 2 also includes the notice 251, which indicates the feature threshold criterion 202 associated with a participant sending a message with the messaging feature 219. This notice 251 can be displayed in GUIs 200 of all participants of the virtual meeting. In some implementations, additional notices 251 can be displayed in the navigation panel 240 to indicate a feature threshold criterion 202 that is associated with one or more of the features 210. For example, a notice 251 can be displayed to indicate a feature threshold criterion 202 associated with using the microphone control feature 213 (e.g., to unmute the participant's microphone). In some implementations, a virtual meeting tool 230 can be selected that causes the navigation panel 240 to display the feature threshold criterion 202 associated with each feature 210 that participants are allowed to use during the virtual meeting.

FIG. 3 is an example graphical user interface (GUI) 300 for token-based feature control in a virtual meeting, according to some aspects of the disclosure. The GUI 300 includes examples of features 310 that participants may use during a virtual meeting, content window 320A-320D, virtual meeting tools 330, and navigation panel 340. The GUI 300 also displays a number of tokens 301A (e.g., unused tokens) currently allocated to the host-participant viewing the GUI 300.

In some implementations, features 310 can be the same as or similar to the features 210 described with reference to FIG. 2. In some implementations, content windows 320A-320D can be the same as or similar to the content windows 220A-220D described with reference to FIG. 2. In the illustrative FIG. 3, content window 320A represents the host-participant 321A (e.g., the meeting host), content window 320B represents participant 321B, content window 320C represents participant 321C, and content window 320D represents participant 321D. In some implementations, the virtual meeting tools 330 can be the same as or similar to the virtual meeting tools 230 described with reference to FIG. 2.

In some implementations, the virtual meeting tools 330 can include an add participant element 331, a participant search element 332, and a participant display element 333. The participant display element 333 can display information pertaining to participants 321 of the virtual meeting (e.g., the host-participant 321A, the participant 321B, the participant 321C, and the participant 321D). For example and in some implementations, the participant display element 333 can display token counts for tokens 301B, tokens 301C, and tokens 301D respectively pertaining to participants 321A-321D. In some implementations, one or more of the add participant element 331, the participant search element 332, or the participant display element 333 may be displayed in the GUI 300 of a non-host participant.

In the illustrative FIG. 3, the navigation panel 340 displays a participant panel for the virtual meeting. In some implementations, the participant panel may be displayed in the navigation panel 340 by selecting the participants element 334. In some implementations, the participant display element 333 in the GUI 300 of the host-participant 321A may include one or more host-specific information or controls. For example and in some implementations, the host-participant 321A may have control to mute or unmute the microphone of participants of the virtual meeting using the participant microphone control element 335. In another example and in some implementations, the host-participant 321A may have multiple host controls which may be accessed by selecting the host control menu element 336.

Controls for the host-participant 321a or organizer (e.g., virtual meeting tools 330 for the host-participant 321A) may include adjusting or viewing settings of a token allocation module (e.g., token allocation module 151 of FIG. 1) of the virtual meeting platform (e.g., virtual meeting platform 120) for the virtual meeting. These settings can include one or more of current token counts for participants of the virtual meeting, an initial allocation number of tokens a participant of the virtual meeting, a feature threshold criterion associated with using a feature 310 of the virtual meeting, or the like. In some implementations, these settings of the token allocation module can be virtual meeting tools 330 that may be accessed by the host-participant in the navigation panel 340 (e.g., using the host control menu element 336).

In some implementations, a token allocation module may allocate an initial number of tokens 301 to each participant at the start of the virtual meeting. In some implementations, the number of tokens 301 allocated to each participant may be based on one or more of characteristics associated with the participant,, an equal distribution, a random distribution, user input received via the GUI 300, or the like. In some implementations, a token allocation module (e.g., token allocation module 151 of FIG. 1) can allocate a number of tokens 301 over time to participants of the virtual meeting. For example, the token allocation module may allocate three tokens to each participant every five minutes of the virtual meeting. In some implementations, the token allocation module can deallocate a number of tokens 301 over time. For example, the token allocation module may deallocate two tokens from each participant every ten minutes of the virtual meeting. In some implementations, the tokens can be allocated continuously over a predetermined period of time. For example, if three tokens are allocated every ten minutes, after four minutes, one token will have been allocated to a participant. In some implementations, the tokens can be allocated only after the time or frequency duration is satisfied. For example, if three tokens are allocated every ten minutes, after four minutes, no tokens will have been allocated to a participant; instead, all three tokens will be allocated after ten minutes. In some implementations, the number of tokens allocated and the frequency of allocation (e.g., the time between allocations/deallocations) can be received as input from a host or organizer of the virtual meeting.

In some implementations, the GUI 300 can present configuration settings for the token allocation module related to predetermined meeting types as virtual meeting tools 330 for the host-participant 321A (or organizer of the virtual meeting). Predetermined meeting types defined by the token allocation module can include, for example, one or more of a presentations, a large group meeting, a small group meeting, a collaboration meeting, a classroom meeting, or the like. The token allocation module can allocate tokens to participants of the virtual meeting based on the type of virtual meeting. Predetermined meeting types may be defined by a virtual meeting platform (e.g., virtual meeting platform 120 of FIG. 1). In some implementations, the predetermined meeting types may be defined by user input received via GUI 300, such as from a host-participant 321A or organizer of the virtual meeting. In some implementations, configuration settings for the token allocation module related to predetermined meeting types can include a number of tokens 301 that are to be allocated to each participant of the virtual meeting for a given predetermined meeting type. For example, for a presentation meeting type, the token allocation module may allocate a larger number of tokens 301 to an identified presenter, and a smaller number of tokens 301 to non-presenters (e.g., participants of the virtual meeting). In another example, for a large group meeting type, the token allocation module may allocate an equal smaller number of tokens 301 to each participant, whereas for a small group meeting type, the token allocation module may allocate an equal larger number of tokens 301 to each participant. In another example, for a collaboration meeting type, the token allocation module may equally allocate a relatively large number of tokens 301 to each participant, or may remove or reduce the feature threshold criteria associated with using features 310 of the virtual meeting (e.g., such that each participant has enough tokens 301 to freely participate using all features 310 of the virtual meeting without concern for running out of tokens 301). In another example, for a classroom meeting type, the token allocation module may allocate less tokens 301 to a student who frequently participates in the virtual meeting, and more tokens 301 to a student who less-frequently participates in the virtual meeting.

In some implementations, the meeting type of the virtual meeting may be changed during the virtual meeting. For example, a virtual meeting may start as a large group meeting where everyone briefly introduces themselves (e.g., using their equally allocated unused tokens), and to a presentation meeting type. A designated presenter can be allocated a large number of tokens 301, while non-presenting participants may have some or all of their tokens 301 deallocated.

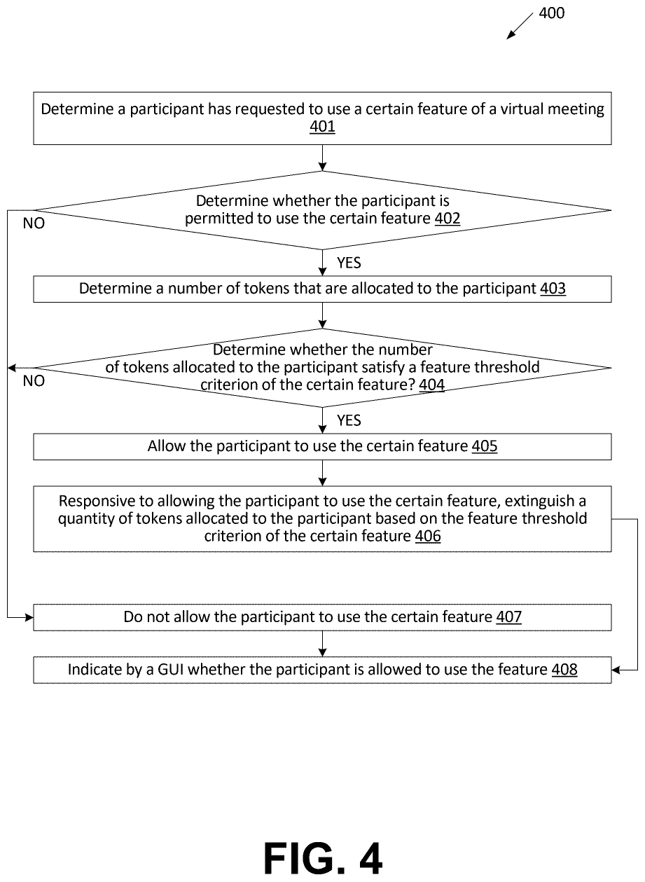

FIG. 4 is a flow diagram of an example method 400 for token-based feature control in a virtual meeting, according to some aspects of the disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every embodiment. Other process flows are possible.

At operation 401, the processing logic performing the method 400 determines a participant has requested to use a certain feature of the virtual meeting. In some implementations, the participant selects a GUI element of the GUI for the virtual meeting associated with using a feature of the virtual meeting. Examples of features that may be used by the participant include one or more of writing a chat message, initiating a participant poll, submitting a question to a question-and-answer session, applying audio and/or visual effects to the content shared by the participant (e.g., a virtual background, voice-changer, etc.), time spent unmuted, time the participant sends audio at a volume level loud enough to trigger effects in the virtual meeting (e.g., speaker-highlight switching), hand raising, or the like. In some implementations, the processing logic can adjust the available features and corresponding feature threshold criterion for respective features to balance the meeting activity or counteract unintended usage of features of the virtual meeting without preventing use of the feature for all participants, or without fully preventing use of a feature for a particular participant.

At operation 402, the processing logic determines whether the participant is permitted to use the certain feature that has been requested. In some implementations, a certain participant of the participants in the virtual meeting may be restricted from using features of the virtual meeting, despite having a sufficient number of allocated tokens. The participant may be restricted for various reasons, including for example, as a temporary time-out for the certain participant, a temporary pause for all participants (such as when one participant is presenting), or the like. In another example, participants may be restricted from using one or more features if another participant of the virtual meeting is using a particular feature of the virtual meeting. For instance, a participant can be restricted from unmuting their microphone if another participant's microphone is already unmuted, however the participant may not be restricted from using the raise-hand feature. In some implementations, a feature restriction placed on a participant (e.g., the participant is not permitted to use one or more features) does not affect the number of tokens currently allocated to the participant, or future token allocations to the participant. Responsive to determining the participant is permitted to use the certain feature, the processing logic proceeds to operation 403. Responsive to determining the participant is not permitted to use the certain feature, the processing logic proceeds to operation 407.

In some implementations, responsive to determining the participant is not permitted to use the certain feature, the processing logic can increase a value of the feature threshold criterion of the certain feature such that the number of tokens allocated to the participant will no longer satisfy the feature threshold criterion of the certain feature.

At operation 403, responsive to determining the participant is permitted to use the certain feature, the processing logic determines a number of tokens that are allocated to the participant. The number of tokens allocated to the participant can be stored by a token allocation module. In some implementations, the processing logic can allocate additional tokens to the participant. For example, the processing logic can allocate one or more tokens to the participant based on a unit of time. That is, a certain number of tokens can be allocated at a certain frequency (e.g., a certain rate) to the participant. In another example, the processing logic can allocate tokens to the participant based on additional factors, such as use of a certain feature, or in response to a user input (e.g., a user input of a participant-host of the virtual meeting). In another example, the processing logic can allocate tokens to the participant based on the meeting type. That is, the virtual meeting can have a meeting type that indicates a number of tokens to be allocated to participants of the virtual meeting. If the meeting type changes during the virtual meeting, the processing logic can allocate tokens as indicated by the new meeting type.

At operation 404, the processing logic determines whether the number of tokens allocated to the participant satisfy a feature threshold criterion of the certain feature. As described above, the feature threshold criterion can represent a number of tokens that are extinguished or returned to the token allocation module when a participant uses a feature of the virtual meeting. In some implementations, the processing logic can adjust the feature threshold criterion for the certain feature. In some implementations, the feature threshold criterion can be different for different participants. For example, a particular participant can have a feature threshold criterion of one token for the certain feature, while another participant can have a feature threshold criterion of two tokens for the certain feature. In some implementations, responsive to determining the number of tokens allocated to the participant do not satisfy a feature threshold criterion of the certain feature, the processing logic can allocate tokens to the participant, such that the number of tokens allocated to the participant does satisfy the feature threshold criterion.

At operation 405, responsive to determining the number of tokens allocated to the participant satisfy the feature criterion of the certain feature, the processing logic allows the participant to use the certain feature.

At operation 406, responsive to allowing the participant to use the certain feature, the processing logic extinguishes a quantity of tokens allocated to the participant based on the feature threshold criterion of the certain feature. In some implementations, the quantity of tokens is equal to the feature threshold criterion. For example, the feature threshold criterion can be two tokens, and so the quantity of tokens extinguished from the tokens allocated to the participant is two tokens. In alternative implementations, the quantity of tokens is not extinguished, but rather is returned to an allocation token pool of the virtual meeting platform (e.g., of a token allocation module).

At operation 407, responsive to determining, at operation 402, that the participant is not permitted to use the certain feature, or responsive to determining, at operation 404 that the number of tokens allocated to the participant do not satisfy the feature threshold criterion of the certain feature, the processing logic does not allow the participant to use the certain feature.

At operation 408, the processing logic indicates, by a graphical user interface (GUI) whether the participant is allowed to use the certain feature. In some implementations, if the participant is allowed to use the feature, the GUI indicates that the feature has been selected and used, or is in use. In some implementations, if the participant is allowed to use the feature, the GUI affirmatively indicates (e.g., with a notification to the participant) that the participant is allowed to use the first feature. In some implementation, if the participant is not allowed to use the feature, the GUI indicates that the participant is not allowed to use the first feature. In some implementations, if the participant is not allowed to use the feature, the GUI indicates a number of tokens needed by the participant to satisfy the token threshold criterion for the first feature. For example, if the token threshold criterion for the first feature is ten tokens and the number of unused tokens allocated to the participant is seven tokens, the GUI may indicate that the participant is deficient three unused tokens to satisfy the token threshold criterion

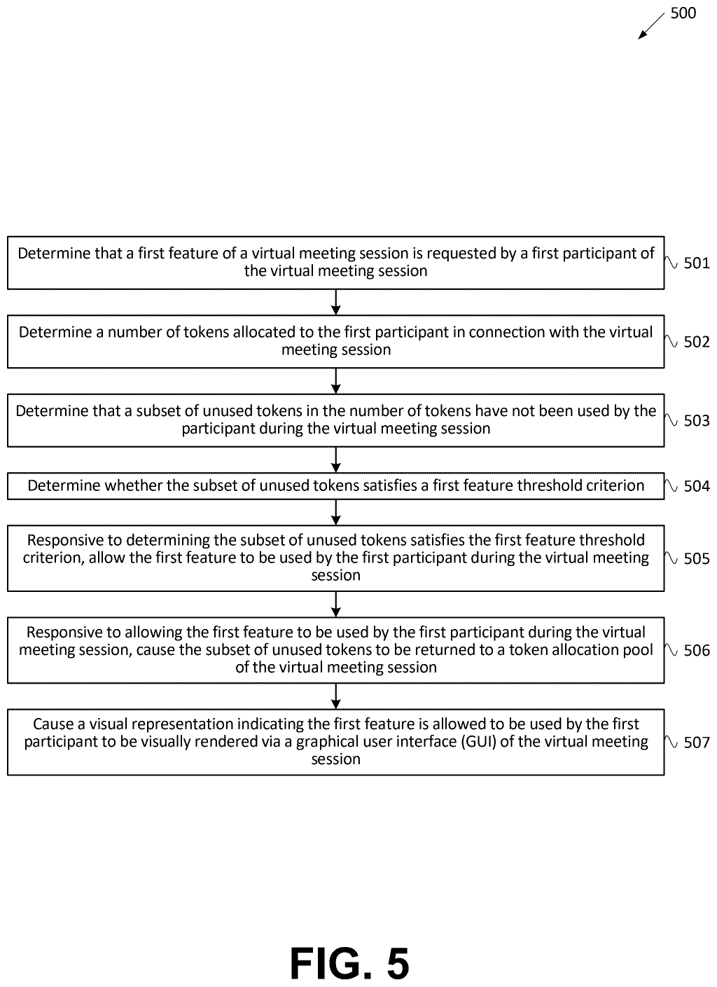

FIG. 5 is a flow diagram of an example method 500 for token-based feature control in a virtual meeting, according to some aspects of the disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every embodiment. Other process flows are possible.

At operation 501, the processing logic determines that a certain feature of a virtual meeting session is requested by a particular participant of the virtual meeting.

At operation 502, the processing logic determines a number of tokens allocated to the particular participant in connection with the virtual meeting.

At operation 503, the processing logic determines that a subset of unused tokens in the number of tokens have not been used by the participant during the virtual meeting session.

At operation 504, the processing logic determines whether the subset of unused tokens satisfies a certain feature threshold criterion. The certain feature threshold criterion can be a criterion for the certain feature.

At operation 505, responsive to determining the subset of unused tokens satisfies the certain feature threshold criterion, the processing logic can allow the certain feature to be used by the particular participant during the virtual meeting session.

At operation 506, responsive to allowing the certain feature to be used by the particular participant during the virtual meeting session, the processing logic can cause the subset of unused tokens to be returned to a token allocation pool of the virtual meeting session.

At operation 507, the processing logic can cause a visual representation indicating the certain feature is allowed to be used by the first participant to be visually rendered via a graphical user interface (GUI) of the virtual meeting session.

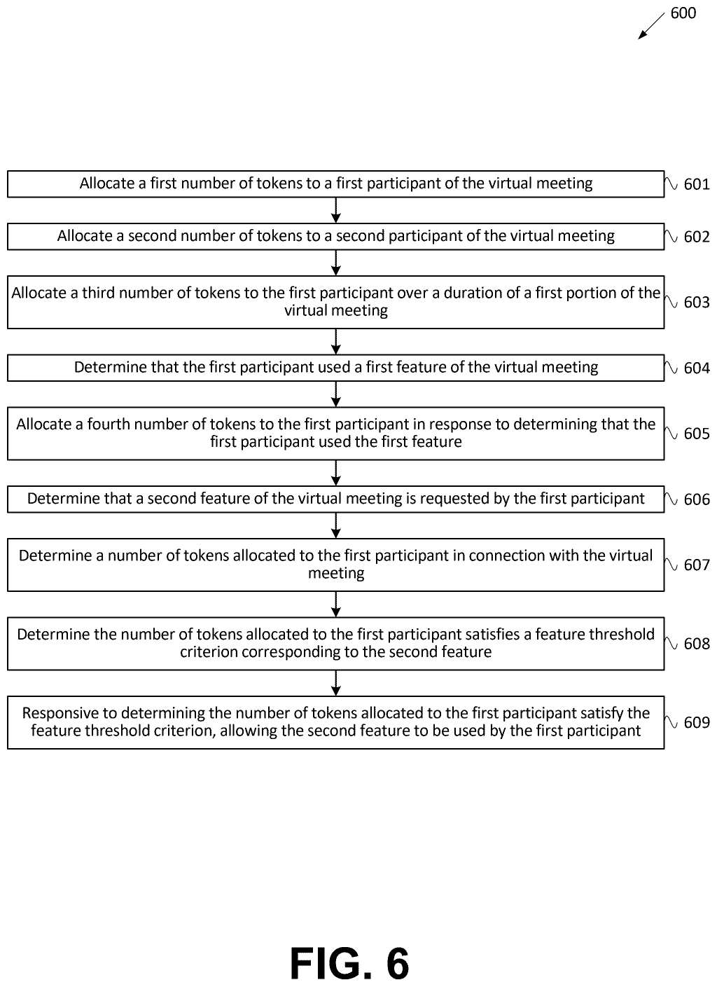

FIG. 6 is a flow diagram of an example method 600 for token-based feature control in a virtual meeting, according to some aspects of the disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every embodiment. Other process flows are possible.

At operation 601, the processing logic allocates a certain number of tokens to a certain participant of the virtual meeting.

At operation 602, the processing logic allocates a different number of tokens to different participant of the virtual meeting.

At operation 603, the processing logic allocates a certain number of tokens to a participant over a duration of a portion of the virtual meeting. The duration of the portion of the virtual meeting can be measured from a time that the participant joined the virtual meeting. In some implementations, the certain number of tokens can be allocated to the participant each time a full duration is completed. For example, if the duration is three minutes, every three minutes the processing logic can allocate tokens to the participant.

At operation 604, the processing logic determines that a participant used a certain feature of the virtual meeting.

At operation 605, responsive to determining in operation 604 that the participant used a certain feature of the virtual meeting, the processing logic allocates a number of tokens to the participant that used the certain feature.

At operation 606, the processing logic determines that a feature of the virtual meeting is requested by a particular participant.

At operation 607, the processing logic determines a number of tokens allocated to the particular participant in connection with the virtual meeting.

At operation 608, the processing logic determines whether the number of tokens allocated to the first participant satisfies a feature threshold criterion corresponding to the second feature.

At operation 609, responsive to determining the number of tokens allocated to the particular participant satisfy the feature threshold criterion, the processing logic allows the requested feature to be used by the particular participant, as received in the request at operation 605.

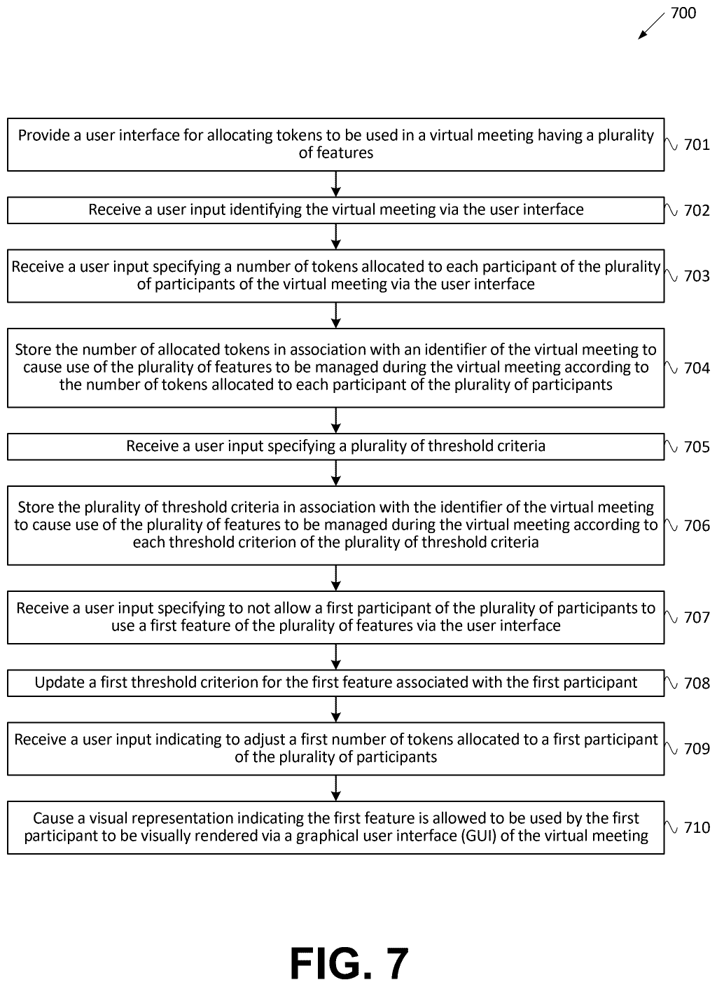

FIG. 7 is a flow diagram of an example method 700 for token-based feature control in a virtual meeting, according to some aspects of the disclosure. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every embodiment. Other process flows are possible.

At operation 701, the processing logic provides a user interface for allocating tokens to be used in a virtual meeting having a plurality of features.

At operation 702, the processing logic receives a user input identifying the virtual meeting via the user interface.

At operation 703, the processing logic receives a user input specifying a number of tokens allocated to each participant of the plurality of participants of the virtual meeting via the user interface.

At operation 704, the processing logic stores the number of allocated tokens in association with an identifier of the virtual meeting to cause use of the plurality of features to be managed during the virtual meeting according to the number of tokens allocated to each participant of the plurality of participants.

At operation 705, the processing logic receives a user input specifying a plurality of threshold criteria.

At operation 706, the processing logic stores the plurality of threshold criteria in association with the identifier of the virtual meeting to cause use of the plurality of features to be managed during the virtual meeting according to each threshold criterion of the plurality of threshold criteria.

At operation 707, the processing logic receives a user input via the user interface, the user input specifying to not allow a particular participant of the plurality of participants to use a certain feature of the plurality of features.

At operation 708, the processing logic updates a certain threshold criterion for the certain feature associated with the particular participant.

At operation 709, the processing logic receives a user input indicating to adjust a certain number of tokens allocated to the particular participant of the plurality of participants.

At operation 710, the processing logic causes a visual representation indicating the first feature is allowed to be used by the particular participant to be visually rendered via a graphical user interface (GUI) of the virtual meeting.

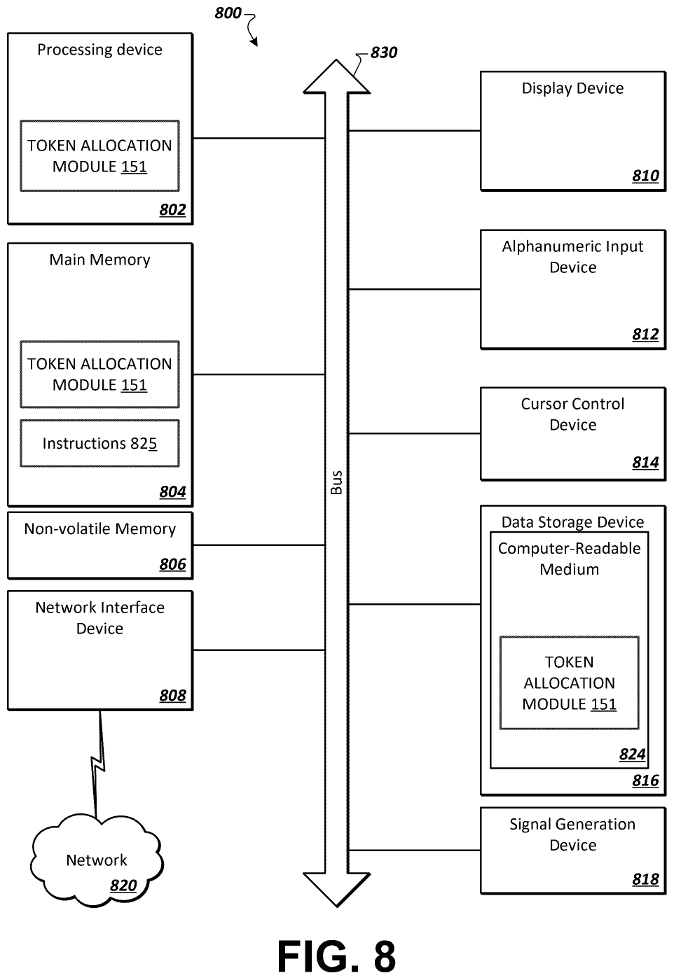

FIG. 8 is a block diagram illustrating an example of a computer system 800, according to aspects of the disclosure. The computer system 800 can correspond to virtual meeting platform 120 and/or client devices 102A-N, described in FIG. 1. Computer system 800 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 800 includes a processing device 802 (e.g., a processor), a main memory 804 (e.g., read-only memory (ROM), flash memory, dynamic random access memory (DRAM) such as synchronous DRAM (SDRAM), double data rate (DDR) SDRAM, or DRAM (RDRAM), etc.), a non-volatile memory 806 (e.g., flash memory, static random access memory (SRAM), etc.), and a data storage device 816, which communicate with each other via a bus 830. In some implementations, the main memory 804 can be a non-transitory computer readable storage medium.

Processing device 802 represents one or more general-purpose processing devices such as a microprocessor, central processing unit, or the like. More specifically, processing device 802 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 can also be one or more special-purpose processing devices such as an application specific integrated circuit (ASIC), a field programmable gate array (FPGA), a digital signal processor (DSP), network processor, or the like. The processing device 802 is configured to execute network interface device 808 (e.g., for synchronizing data between platforms) for performing the operations discussed herein. The processing device 802 can be configured to execute instructions 825 stored in main memory 804. Non-volatile memory 806 can store the instructions 825 when they are not being executed, and can store additional system data that can be accessed by processing device 802.

The computer system 800 can further include a network interface device 808. The computer system 800 also can include a video display unit 810 (e.g., a liquid crystal display (LCD) or a cathode ray tube (CRT)), an input device 812 (e.g., a keyboard, and alphanumeric keyboard, a motion sensing input device, touch screen), a cursor control device 814 (e.g., a mouse), and a signal generation device 818 (e.g., a speaker).

The data storage device 816 can include a computer-readable storage medium 824 (e.g., a non-transitory machine-readable storage medium) on which is stored one or more sets of instructions 825 (e.g., for generating variations of a translated audio portion) embodying any one or more of the methodologies or functions described herein. The instructions can also reside, completely or at least partially, within the main memory 804 and/or within the processing device 802 during execution thereof by the computer system 800, the main memory 804 and the processing device 802 also constituting machine-readable storage media. The instructions can further be transmitted or received over a network 820 via the network interface device 808.

While the computer-readable storage medium 824 (non-transitory computer-readable storage medium) is illustrated in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a specific feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the specific features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specific by the execution of software thereon that enables hardware to perform specific functions (e.g., generating interest points and/or descriptors); software on a computer readable medium; or a combination thereof.

The aforementioned systems, circuits, modules, and so on have been described with respect to interactions between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
determining that a first feature of a virtual meeting is requested by a first participant of the virtual meeting;
determining a number of tokens allocated to the first participant in connection with the virtual meeting;
determining that a subset of unused tokens of the number of tokens have not been used by the participant during the virtual meeting;
determining whether the subset of unused tokens satisfies a first feature threshold criterion; and
responsive to determining the subset of unused tokens satisfies the first feature threshold criterion, allowing the first feature to be used by the first participant during the virtual meeting.

2. The method of claim 1, further comprising:
responsive to determining the subset of unused tokens does not satisfy the first feature threshold criterion, disallowing the first feature to be used by the first participant during the virtual meeting.

3. The method of claim 1, further comprising:
causing a visual representation indicating that the first feature is allowed to be used by the first participant to be visually rendered via a graphical user interface (GUI) of the virtual meeting.

4. The method of claim 1, further comprising:
determining to disallow the first participant to use the first feature; and
responsive to determining to disallow the first participant to use the first feature, increasing the first threshold criterion such that the subset of unused tokens does not satisfy the first feature threshold criterion.

5. The method of claim 1, further comprising:
allocating a first number of tokens to the subset of unused tokens of the first participant during the virtual meeting; and
allocating a second number of tokens to a second subset of unused tokens of a second participant of the virtual meeting during the virtual meeting.

6. The method of claim 1, further comprising:
allocating a first number of tokens to the subset of unused tokens of the first participant during a portion of the virtual meeting session.

7. The method of claim 1, further comprising:
determining that the first participant has used a second feature of the virtual meeting session; and
allocating a first number of tokens to the first participant in response to determining that the first participant has used the second feature.

8. The method of claim 1, further comprising:
responsive to allowing the first feature to be used by the first participant during the virtual meeting session, causing the subset of unused tokens to be returned to a token allocation pool of the virtual meeting session.

9. A method comprising:
providing a user interface for allocating tokens to be used in a virtual meeting having a plurality of features;
receiving a user input identifying the virtual meeting via the user interface;
receiving a user input specifying a number of tokens allocated to each participant of a plurality of participants of the virtual meeting via the user interface; and
storing the number of allocated tokens in association with an identifier of the virtual meeting to cause use of the plurality of features to be managed during the virtual meeting according to the number of tokens allocated to each participant of the plurality of participants.

10. The method of claim 9, further comprising:
receiving a user input specifying a plurality of threshold criteria, each threshold criterion of the plurality of threshold criteria pertaining to a feature of the plurality of features; and
storing the plurality of threshold criteria in association with the identifier of the virtual meeting to cause use of the plurality of features to be managed during the virtual meeting according to each threshold criterion of the plurality of threshold criteria.

11. The method of claim 9, further comprising:
receiving a user input specifying to not allow a first participant of the plurality of participants to use a first feature of the plurality of features via the user interface; and
updating a first threshold criterion for the first feature associated the first participant.

12. The method of claim 9, further comprising:
receiving a user input specifying to not allow the plurality of participants to use a first feature of the plurality of features via the user interface; and
updating a first threshold criterion for the first feature associated with the plurality of participants.

13. The method of claim 9, further comprising:
receiving a user input indicating to adjust a first number of tokens allocated to a first participant of the plurality of participants; and
updating a first number of allocated tokens in association with the identifier of the virtual meeting corresponding to the first participant.

14. The method of claim 9, further comprising:
receiving a user input indicating to not allow a sub-plurality of the plurality of participants to use the plurality of features; and
updating the number of allocated tokens in association with the identifier of the virtual meeting to not allow the sub-plurality of participants to use the plurality of features of the virtual meeting.

15. A system comprising:
a memory; and
one or more processing devices coupled to the memory, the one or more processing devices to perform operations comprising:
determining that a first feature of a virtual meeting is requested by a first participant of the virtual meeting;
determining a number of tokens allocated to the first participant in connection with the virtual meeting;
determining that a subset of unused tokens of the number of tokens have not been used by the participant during the virtual meeting;
determining whether the subset of unused tokens satisfies a first feature threshold criterion; and
responsive to determining the subset of unused tokens satisfies the first feature threshold criterion, allowing the first feature to be used by the first participant during the virtual meeting.

16. The system of claim 15, the operations further comprising:
responsive to determining the subset of unused tokens does not satisfy the first feature threshold criterion, disallowing the first feature to be used by the first participant during the virtual meeting.

17. The system of claim 15, the operations further comprising:
determining to disallow the first participant to use the first feature; and
responsive to determining to disallow the first participant to use the first feature, increasing the first threshold criterion such that the subset of unused tokens does not satisfy the first feature threshold criterion.

18. The system of claim 15, the operations further comprising:
allocating a first number of tokens to the subset of unused tokens of the first participant during the virtual meeting; and
allocating a second number of tokens to a second subset of unused tokens of a second participant of the virtual meeting during the virtual meeting.

19. The system of claim 15, the operations further comprising:
allocating a first number of tokens to the subset of unused tokens of the first participant during a portion of the virtual meeting session.

20. The system of claim 15, the operations further comprising:
determining that the first participant has used a second feature of the virtual meeting session; and
allocating a first number of tokens to the first participant in response to determining that the first participant has used the second feature.
